(19) United States
(12) Patent Application Publication
(10) Pub. No.: US 2024/0281203 A1
(43) Pub. Date: Aug. 22, 2024

(54) INFORMATION PROCESSING DEVICE, INFORMATION PROCESSING METHOD, AND STORAGE MEDIUM

(71) Applicant: Sony Group Corporation, Tokyo (JP)

(72) Inventor: Takayoshi SHIMIZU, Chiba (JP)

(73) Assignee: Sony Group Corporation, Tokyo (JP)

(21) Appl. No.: 18/572,475

(22) PCT Filed: Mar. 9, 2022
(86) PCT No.: PCT/JP2022/010264

§ 371 Date: Dec. 20, 2023

(30) Foreign Application Priority Data
Jul. 8, 2021 (JP) 2021-113329

(51) Int. Cl. G06F 3/16; G06F 3/01; G06T 15/00; G10L 15/26

(52) U.S. Cl. CPC G06F 3/165; G06F 3/017; G06T 15/005; G10L 15/26

(57) ABSTRACT

An information processing device includes an emphasis information generation unit that generates control information for performing emphasis control on audio including an environmental sound in a virtual space and an utterance voice of a second user associated with a second avatar arranged in the virtual space on the basis of interest information of a first user associated with a first avatar arranged in the virtual space.

### TECHNICAL FIELD

The present technology relates to a technical field of an information processing device, an information processing method, and a storage medium which perform processing for audio reproduction using a virtual space.

### BACKGROUND ART

There is known a technology of enhancing a sense of immersion in an event or the like held in a virtual space by arranging a virtual character such as an avatar associated with a user in the virtual space and performing audio reproduction in accordance with a position of the virtual character in the virtual space.

For example, Patent Document 1 below describes that, when a voice acquired from an actual space is output as voice data in a virtual space, an effect is applied to the voice from the actual space on the basis of a listening position or the like in the virtual space to perform the output. This makes it possible to enhance a sense of immersion in the virtual space.

### CITATION LIST

### Patent Document

Patent Document 1: Japanese Patent Application Laid-Open No. 2020-188435

### SUMMARY OF THE INVENTION

### Problems to be Solved by the Invention

However, there are audio that a user desires to listen to and audio that the user does not desire to listen to, and audio reproduction that is always preferred by the user is not necessarily performed if the effect is similarly applied to output both types of audio.

The present technology has been made in view of such a problem, and an object thereof is to provide a user experience with appropriate audio reproduction in an event in which the user can participate remotely.

### Solutions to Problems

An information processing device according to the present technology includes an emphasis information generation unit that generates control information for performing emphasis control on audio including an environmental sound in a virtual space and an utterance voice of a second user associated with a second avatar arranged in the virtual space on the basis of interest information of a first user associated with a first avatar arranged in the virtual space.

The interest information is interest information related to audio. Then, the audio includes the environmental sound, the utterance voice, and the like. The environmental sound includes a sound generated in the virtual space, for example, a playing sound in a music concert, an announcement broadcast sound for conveying a start of performance, a voice emitted from a performer, and the like. Furthermore, the utterance voice includes voices uttered by viewers and the like.

Each of the viewers can experience the audio in accordance with a position of an avatar arranged as his/her own virtual self in the virtual space.

The information processing device generates control information for performing emphasis control on either the environmental sound or the utterance voice or control information for performing emphasis control on the both on the basis of the interest information of the first user.

### BRIEF DESCRIPTION OF DRAWINGS

FIG. 1 is a view for describing an outline of a concert held in a virtual space.

FIG. 2 is a block diagram illustrating a configuration example of a provision system.

FIG. 3 is a block diagram illustrating a configuration example of a client system.

FIG. 4 is a block diagram of a computer device.

FIG. 5 is a flowchart illustrating an example of a flow of processing related to machine learning.

FIG. 6 is a flowchart illustrating a flow of volume adjustment processing in a first embodiment.

FIG. 7 is a flowchart illustrating another example of the flow of the volume adjustment processing in the first embodiment.

FIG. 8 is a flowchart illustrating a flow of volume adjustment processing in a second embodiment.

FIG. 9 is a view for describing a technique for determining whether or not a user is located in a permitted area.

FIG. 10 is a view illustrating an example of three-dimensional text arranged in a virtual space.

FIG. 11 is a flowchart illustrating a flow of volume adjustment processing in a third embodiment.

FIG. 12 is a view for describing an example of changing a display color of an avatar.

FIG. 13 is a view for describing an example of performing display for providing notification of a voice chat start request.

FIG. 14 is a view for describing an example of moving an avatar in a pseudo manner.

FIG. 15 is a flowchart illustrating a flow of processing for performing emphasis control in a fourth embodiment.

### MODE FOR CARRYING OUT THE INVENTION

Hereinafter, embodiments according to the present technology will be described in the following order with reference to the accompanying drawings.
<1. System Configuration>
<2. Computer Device>
<3. First Embodiment>
<4. Second Embodiment>
<5. Third Embodiment>
<6. Fourth Embodiment>
<7. Modifications>
<8. Summary>
<9. Present Technology>

### 1. System Configuration

A system configuration for providing entertainment using a virtual space VS will be described with reference to the attached drawings.

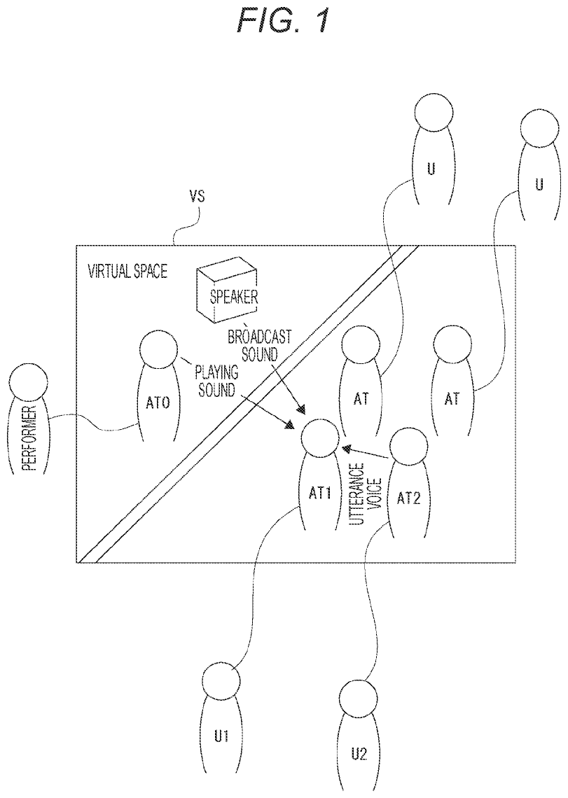

First, an outline of the entertainment provided to a user using the virtual space VS will be described with reference to FIG. 1. Note that various types of entertainment can be considered as the entertainment provided to the user, but a music concert will be described as an example in the following description.

In the virtual space VS, a three-dimensional object imitating a performer such as a player or a singer is arranged. A movement of the performer is reproduced in the virtual space VS by being linked to a movement of a performer in an actual space. The movement of the performer, that is, a movement of a joint is obtained from, for example, a plurality of captured images obtained by capturing the performer from various angles.

The performer is a target object that the user pays attention to in the virtual space VS.

Examples of a form of the performer in the virtual space VS include a live-action person or a virtual character projected on a screen installed in a concert venue, a live-action volumetric imaging body, a computer graphics (CG) character of a virtual character, and the like. Furthermore, an exhibited moving image, an exhibited image, or the like as an exhibit is one form of the performer in an exhibition or the like.

In the following description, a case where the performer is a live-action figure or a virtual character will be described as an example.

In the virtual space VS, avatars AT which are virtual characters associated with users are arranged. The avatars AT in the virtual space VS act in response to movements or operations of the users, respectively.

For example, a face of the avatar AT arranged in the virtual space VS may face right when a user faces right.

Alternatively, the avatar AT in the virtual space VS may move in response to a user moving in the actual space, or the avatar AT may move in the virtual space VS as a user operates a controller.

Furthermore, in response to a user talking in the actual space, an utterance content may be delivered to another user operating another avatar AT arranged near the avatar AT of the user in the virtual space VS. In other words, the user can talk to another user arranged virtually in the vicinity in the virtual space VS.

Then, audio reproduction based on the utterance content may be performed in accordance with a distance and a direction with respect to the avatar AT of the uttering user. In other words, in a case where the avatar AT of the uttering user is located on the right side of the avatar AT of the user who is a listener, audio is reproduced so as to be heard from the right side, and loudness of a reproduced sound thereof depends on the distance between both the avatars.

Furthermore, audio reproduction is also performed for a playing sound by the above-described player and a singing voice by a singer in accordance with a distance and a direction between the avatar AT and the performer or the singer. Of course, audio reproduction may be performed such that the playing sound or the singing voice can be heard from a speaker arranged in the virtual space VS. In this case, the audio reproduction in accordance with a positional relationship or a distance between the avatar AT and the speaker is performed.

In such a virtual space VS, audio reproduction is performed with respect to the avatar AT as if various types of audio were heard from various directions.

In an example illustrated in FIG. 1, the avatars AT respectively associated with users U are arranged in the virtual space VS. Moreover, an avatar AT0, which is a three-dimensional object for the performer, is arranged in the virtual space VS.

For a first user U1 who operates a first avatar AT1, audio reproduction is performed such that a playing sound or a singing voice heard from the performer via the avatar AT0, a sound such as an in-house broadcast heard from the speaker, an utterance voice of a second user U2 heard from a second avatar AT2 of the second user U2, and the like are heard from different directions.

Note that sounds other than an utterance voice of the user U related to a voice chat will be referred to as “environmental sounds” in the following description. That is, the environmental sounds refer to the playing sound, the singing voice by the singer, the sound of the in-house broadcast, and the like.

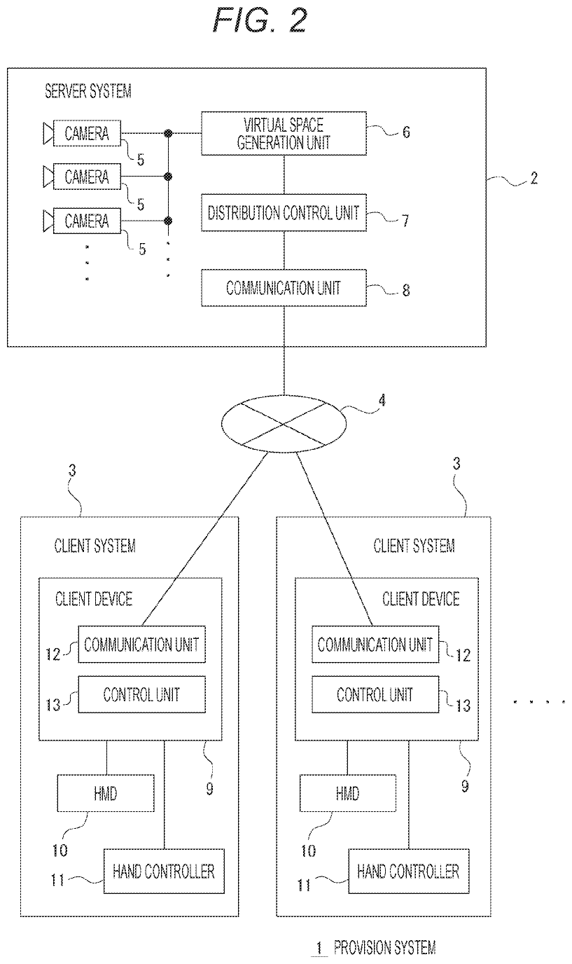

FIG. 2 illustrates an example of a configuration of a provision system 1 configured to provide such an experience to the user U.

The provision system 1 in the present embodiment includes a server system 2 and a client system 3, and the server system 2 and the client system 3 can communicate with each other via a communication network 4.

The server system 2 is a system configured to provide an entertainment environment using the virtual space VS, and includes one or a plurality of information processing devices.

The server system 2 may be provided for every content as entertainment to be provided, or a plurality of contents may be provided by one server system 2.

For example, in the case of music concerts, an environment for experiencing one concert may be provided using a certain server system 2, and an environment for experiencing another concert may be provided using another server system 2.

The server system 2 includes a plurality of cameras 5 that captures images of a player or a singer from various angles, a virtual space generation unit 6, a distribution control unit 7, and a communication unit 8.

The cameras 5 are arranged around a performer in an actual space, and capture the performer to obtain captured images.

The respective captured images (videos) captured by the respective cameras 5 are supplied to the virtual space generation unit 6 in a synchronized state.

In the virtual space generation unit 6, a three-dimensional object for the performer is generated from the plurality of captured images. The generated three-dimensional object is arranged in the virtual space VS. A texture image is pasted on a surface of the three-dimensional object of the performer. As the texture image, the captured images obtained by capturing the performer may be used, or an image of a virtual person may be used. That is, a person captured by the cameras 5 and a person displayed as the performer in the virtual space VS may be different.

The virtual space generation unit 6 generates three-dimensional objects of a structure on a stage and a structure arranged in a guest seat or acquires the three-dimensional objects from another information processing device, and arranges the three-dimensional objects in the virtual space VS.

In this manner, the virtual space VS in which various three-dimensional objects are arranged is generated by the virtual space generation unit 6.

The distribution control unit 7 transmits information regarding the virtual space VS to the client system 3 that is used by the user U whose avatar is arranged in the virtual space VS in which the concert is being held among the client systems 3 connected to the server system 2.

The communication unit 8 transmits the information regarding the virtual space VS and the like to each of the client systems 3 via the communication network 4 under the control of the distribution control unit 7. Furthermore, the communication unit 8 receives information from the client system 3. The information to be received from the client system 3 is, for example, information requesting entry of a new user U to the virtual space VS.

Furthermore, the server system 2 may include a user management function for managing the user U who can use various functions to be provided. For example, a user registration function, a deregistration function, a login function, and the like may be provided.

Information regarding user registration, information regarding deregistration, and information regarding login are provided to the server system 2 via the communication unit 8.

Note that a plurality of rooms is provided for one virtual space VS in an example to be described later. The three-dimensional objects such as the performer and the structure on the stage in each of the rooms are common objects between the rooms. That is, a movement of the performer is the same in each of the rooms.

In contrast, an arrangement of the avatars AT respectively associated with the users U is different for each of the rooms. For example, in a case where the number of the users U who can enter one room is twenty, the common three-dimensional objects associated with the performer and the like and twenty avatars AT associated with twenty users U having entered the room are arranged in the virtual space VS for the room.

In this manner, a processing load in the client system 3 such as display processing regarding the virtual space VS is reduced by suppressing the number of three-dimensional objects to be arranged in the virtual space VS as one room.

The client system 3 is provided for every user U who uses the entertainment environment provided by the server system 2, and includes one or a plurality of information processing devices.

Various configurations of the client system 3 can be considered. In the example illustrated in FIG. 2, a client device 9, which is an information processing device such as a personal computer, a smartphone, a game machine main body, or a playback device of a recording medium, a head mounted display (HMD) 10 connected to the client device 9, and a hand controller 11 are provided.

In addition to these, the client system 3 may include a head mounted device having both the function of the client device 9 and the function of the HMD 10, and the hand controller 11, the client system 3 may include a keyboard instead of the hand controller 11, or the client system 3 may be configured without the hand controller 11 or the keyboard.

The client device 9 includes a communication unit 12 and a control unit 13.

The client device 9 includes the communication unit 12 that transmits and receives information to and from the server system 2 and another client system 3 via the communication network 4, and the control unit 13 that performs various types of processing.

For example, the control unit 13 generates an image to be displayed on a display unit included in the HMD 10 on the basis of the information regarding the virtual space VS received from the server system 2. The user U can experience as if he/she entered the virtual space VS by visually recognizing the image displayed on the display unit of the HMD 10.

The image generated by the control unit 13 is appropriately changed by a movement of the HMD 10 or an operation of the user U with respect to the hand controller 11. This will be specifically described later.

The HMD 10 is an information processing device used by being worn on a head of the user U, and performs processing of displaying an image on the basis of information received from the client device 9 and processing of transmitting information regarding a position and an orientation of the HMD 10 to the client device 9.

The hand controller 11 includes, for example, two information processing devices, and is used by the user U holding one by one with both hands.

The hand controller 11 is provided with a vibration unit that vibrates on the basis of a tactile signal received from the client device 9, various operation elements, and the like.

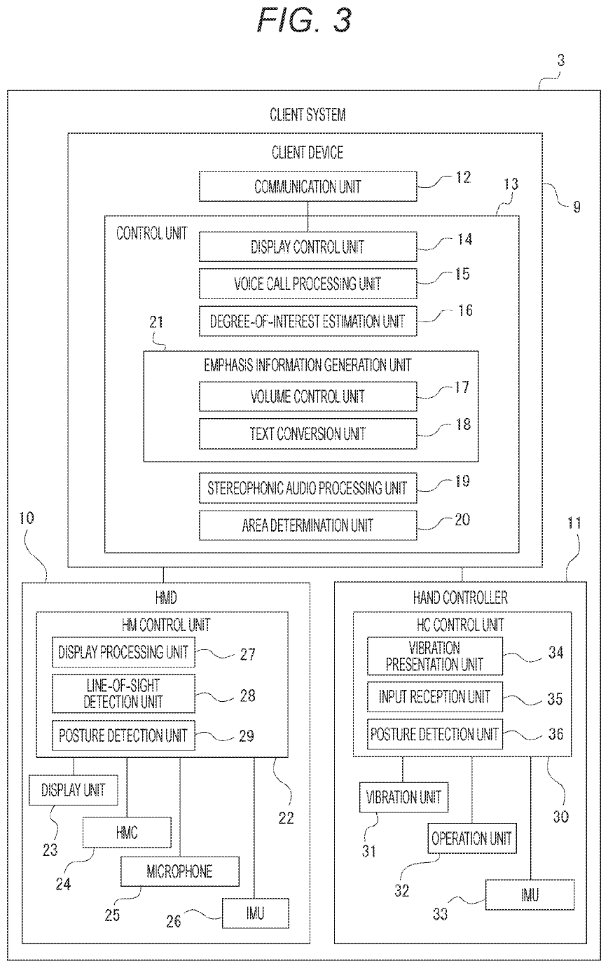

Specific configuration examples of the client device 9, the HMD 10, and the hand controller 11 included in the client system 3 will be described with reference to FIG. 3.

The client device 9 includes a communication unit 12 and a control unit 13, and the control unit 13 includes a display control unit 14, a voice call processing unit 15, a degree-of-interest estimation unit 16, a volume control unit 17, a text conversion unit 18, a stereophonic audio processing unit 19, and an area determination unit 20.

The display control unit 14 generates an image that needs to be displayed on the display unit of the HMD 10 as a display image on the basis of three-dimensional information of the virtual space VS received from the server system 2 and posture information of the HMD 10 obtained from the HMD 10.

Furthermore, the display control unit 14 performs processing of determining display positions of a three-dimensional object such as an icon to be arranged in the virtual space VS or information such as a user name to be superimposed on the avatar AT of another user U, and reflecting the display positions onto the display image.

Moreover, the display control unit 14 performs processing of adding a menu display or the like to the display image.

The voice call processing unit 15 performs communication processing related to a voice chat between the users U, that is, a voice chat between the client systems 3. This processing is performed via the communication unit 12 and the communication network 4.

Information regarding a voice chat target user U is provided to the stereophonic audio processing unit 19.

The degree-of-interest estimation unit 16 performs estimation processing regarding the degree of interest of the user U wearing the HMD 10 and the hand controller 11. Specifically, audio reproduction is performed such that various types of audio can be heard from various directions as illustrated in FIG. 1 on the basis of an arrangement position of the avatar AT in the virtual space VS. There is a case where reproducing all these types of audio is not preferable for the user U.

The degree-of-interest estimation unit 16 performs processing of estimating the degree of interest of the user U for these various types of audio (the above-described environmental sound and the utterance voice).

The estimation processing by the degree-of-interest estimation unit 16 is performed using all sorts of information. For example, posture information of the HMD 10 is acquired to estimate a three-dimensional object of high interest of the user U, and audio to be emitted from the three-dimensional object is specified as audio with a high degree of interest.

Furthermore, audio with a high degree of interest may be specified by acquiring posture information of the hand controller 11 possessed by the user U to detect a pointing motion of the user U and estimate the three-dimensional object of high interest.

Moreover, the three-dimensional object of high interest may be estimated by a selection operation of the user U using a menu screen or the like that is displayed on the display unit of the HMD 10 and is visually recognizable by the user U.

Alternatively, the three-dimensional object of high interest may be estimated on the basis of a line-of-sight direction of the user U estimated from an image captured by a camera included in the HMD 10.

Furthermore, not only the above-described method of estimating the degree of interest of the user U by estimating the three-dimensional object of high interest, but also other methods are conceivable. For example, in a case where it is detected that the user U is singing along with the performer's singing, it may be estimated that the interest in the performer or music being played is high.

Moreover, in a case where it is detected that the user U is getting into a rhythm or dancing in accordance with the performer's singing, it may be estimated that interest in the performer or the music being played is high.

Furthermore, music and the like with a high degree of interest may be registered, and a level of the degree of interest may be estimated using matching or similarity with them as will be described later.

In addition, the degree of interest of the user U may be estimated by acquiring biological information of the user U such as pulse and body temperature.

In this manner, the degree-of-interest estimation unit 16 estimates the three-dimensional object estimated to have a high interest of the user U, and specifies audio to be emitted from the three-dimensional object as audio with a high degree of interest.

The volume control unit 17 and the text conversion unit 18 are provided as an emphasis information generation unit 21.

The emphasis information generation unit 21 generates emphasis information for emphasizing (adjusting) various types of audios according to the degree of interest of the user U.

For example, description will be given using a “playing sound” heard from the performer or the speaker and an “utterance voice” in a voice chat as an example of a plurality of types of audio. In a case where the degree-of-interest estimation unit 16 estimates that the user U is interested in the playing sound rather than the utterance voice, the volume control unit 17 performs volume control for emphasizing the playing sound. This will be specifically described later.

The text conversion unit 18 performs processing of converting the utterance voice into text. In the text conversion processing, for example, in a case where the degree-of-interest estimation unit 16 estimates that the user U is highly interested in the playing sound, it is conceivable to perform presentation using the text generated by the text conversion unit 18 on the utterance voice instead of the audio reproduction.

The text presentation with respect to the user U includes not only a case where simple character information is presented but also a case where characters (hereinafter referred to as “three-dimensional text”) as a three-dimensional object are presented in the virtual space VS. In this case, the text conversion unit 18 generates character information as a three-dimensional object.

In a case where the degree-of-interest estimation unit 16 estimates that the user U is interested in the utterance voice rather than the playing sound, the emphasis information generation unit 21 may perform processing of moving a position of the avatar AT of the user U who has uttered the voice chat, that is, the user U as a conversation partner, close to the avatar AT of the user U who is a listener in a pseudo manner, in addition to (or instead of) the volume adjustment by the volume control unit 17. This processing can be regarded as processing for emphasizing the utterance voice.

The stereophonic audio processing unit 19 executes processing for performing stereophonic audio reproduction in accordance with generation positions of various types of audio in the virtual space VS, a positional relationship of the avatar AT specified on the basis of the information regarding the voice chat target user U received from the voice call processing unit 15 described above, and the like.

Stereophonic audio processing includes attenuation processing based on a listening position and a listening direction of audio, processing of calculating an audio effect from an audio generation position to arrival at the avatar AT, processing for an echo, and the like.

Furthermore, the stereophonic audio processing unit 19 performs the stereophonic audio processing by reflecting the volume adjustment determined on the basis of the degree of interest as described above.

The area determination unit 20 determines whether a position of the avatar AT is located in a permitted area where the voice chat is permitted or a non-permitted area where the voice chat is not permitted.

The stereophonic audio processing unit 19 may reflect a determination result by the area determination unit 20 in the stereophonic audio processing. For example, in a case where the avatar AT is located in the non-permitted area, stereophonic audio reproduction related to the voice chat is not necessarily performed.

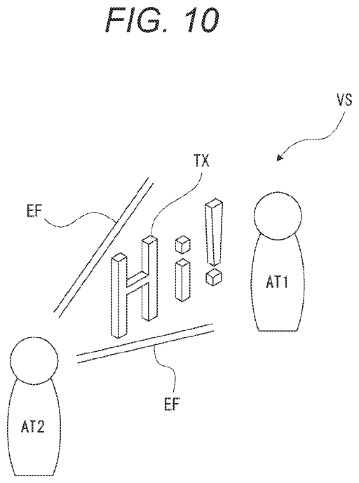

In the example illustrated in FIG. 10, the HMD 10 includes an HM control unit 22, a display unit 23, a head mounted camera (HMC) 24, a microphone 25, and an inertial measurement unit (IMU) 26.

The HM control unit 22 performs overall control of the HMD 10.

The HM control unit 22 performs processing of transmitting a detection signal indicating a posture obtained in the IMU 26 and a voice signal obtained in the microphone 25 to the client device 9. Furthermore, the HM control unit 22 performs processing of receiving information of the virtual space VS in which various three-dimensional objects are arranged from the client device 9, and the like.

Note that FIG. 3 does not illustrate a communication unit included in the HMD 10.

The display unit 23 is a device such as a screen arranged in front of an eyeball of the user U wearing the HMD 10, and displays a display image generated by the HM control unit 22.

The HMC 24 is a camera or the like that captures an image around the eye of the user U wearing the HMD 10. The line-of-sight direction of the user U is detected on the basis of the captured image of the eye captured by the HMC 24.

The microphone 25 is provided to pick up the utterance voice of the user U wearing the HMD 10, and a voice input to the microphone 25 is converted into voice data and supplied to the voice call processing unit 15 of the client device 9 via the HM control unit 22.

The IMU 26 includes an acceleration sensor, a gyro sensor, and the like, and outputs a detection signal for estimating the posture of the HMD 10 to the HM control unit 22.

The IMU 26 may include a temperature sensor to enable correction based on temperature characteristics.

The HM control unit 22 includes a display processing unit 27, a line-of-sight detection unit 28, and a posture detection unit 29.

The display processing unit 27 performs processing for displaying a display image on the display unit 23.

The line-of-sight detection unit 28 detects the line-of-sight direction of the user U on the basis of the image captured by the HMC 24. The detected line-of-sight direction is used to estimate the degree of interest of the user U as described above.

The posture detection unit 29 detects the posture of the HMD 10 on the basis of a signal supplied from the IMU 26. Information regarding the detected posture is supplied to the control unit 13 of the client device 9.

In the example illustrated in FIG. 10, the hand controller 11 includes a hand controller (HC) control unit 30, a vibration unit 31, an operation unit 32, and an IMU 33.

The HC control unit 30 performs overall control of the hand controller 11.

The vibration unit 31 vibrates on the basis of the tactile signal supplied from the HC control unit 30 to present a tactile stimulus to the user U.

The operation unit 32 is provided as an operation element such as a button, receives an operation performed by the user U, and supplies a detection signal to the HC control unit 30.

The IMU 33 includes an acceleration sensor, a gyro sensor, and the like, and outputs a detection signal for estimating a posture of the hand controller 11 to the HC control unit 30.

The IMU 33 may include a temperature sensor to enable correction based on temperature characteristics.

The HC control unit 30 includes a vibration presentation unit 34, an input reception unit 35, and a posture detection unit 36.

The vibration presentation unit 34 supplies a tactile signal to the vibration unit 31.

The input reception unit 35 receives a detection signal regarding an operation of the user U from the operation unit 32 and performs processing corresponding to the operation. For example, processing corresponding to a selection operation for the menu display, an operation of designating a three-dimensional object of interest, or an operation of specifying the avatar AT for the voice chat target user U is performed.

The posture detection unit 36 detects the posture of the hand controller 11 on the basis of a signal supplied from the IMU 33. Information regarding the detected posture is supplied to the control unit 13 of the client device 9.

The client device 9, the HMD 10, and the hand controller 11 can transmit and receive information in a wireless or wired manner.

Note that the control unit 13 of the client device 9 does not need to have all the configurations illustrated in FIG. 3. For example, in a case where it is not necessary to convert the utterance content in the voice chat into text, the text conversion unit 18 is not necessarily provided.

Various configurations of the communication network 4 illustrated in FIG. 2 can be considered. For example, the Internet, an intranet, an extranet, a local area network (LAN), a community antenna television (CATV) communication network, a virtual private network, a telephone line network, a mobile communication network, a satellite communication network, and the like are assumed as the communication network 4.

Furthermore, various examples are also assumed for transmission media constituting the whole or a part of the communication network 4. For example, the present technology can be used in a wired manner such as Institute of Electrical and Electronics Engineers (IEEE) 1394, a universal serial bus (USB), power line conveyance, or a telephone line, or in a wireless manner such as infrared rays such as infrared data association (IrDA), Bluetooth (registered trademark), 802.11 radio, a mobile phone network, a satellite line, or a terrestrial digital network.

### 2. Computer Device

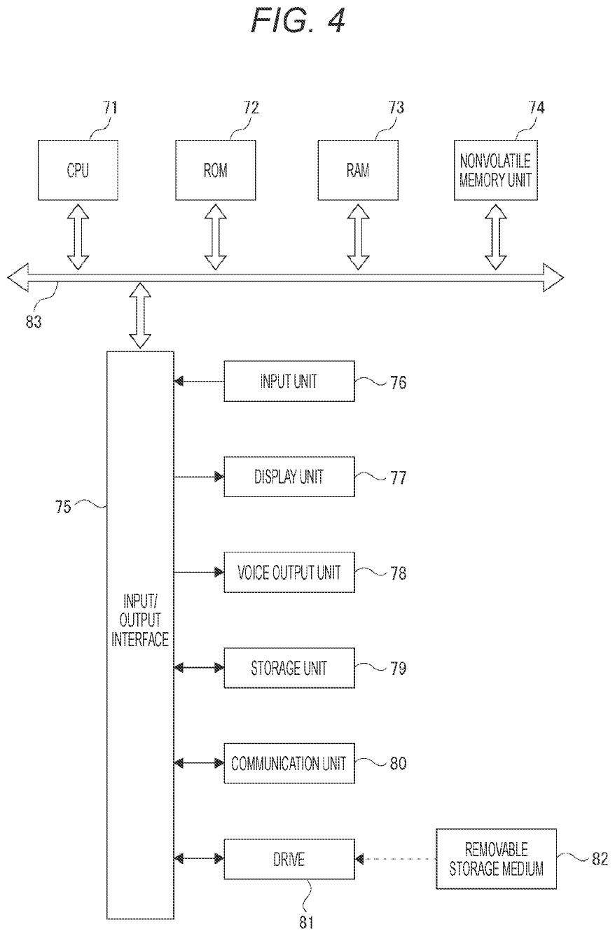

A configuration example of a computer device including an arithmetic processing unit that realizes the server system 2 and the client system 3 included in the provision system 1 will be described with reference to FIG. 4.

A CPU 71 of the computer device functions as the arithmetic processing unit which performs the above-described various type of processing, and executes the various type of processing in accordance with a program stored in a nonvolatile memory unit 74 such as a ROM 72 or, for example, an electrically erasable programmable read-only memory (EEP-ROM), or a program loaded from a storage unit 79 to a RAM 73. Furthermore, the RAM 73 also appropriately stores data and the like necessary for the CPU 71 to execute the various types of processing.

The CPU 71, the ROM 72, the RAM 73, and the nonvolatile memory unit 74 are connected to one another via a bus 83. An input/output interface (I/F) 75 is also connected to the bus 83.

An input unit 76 including an operation element and an operation device is connected to the input/output interface 75.

For example, as the input unit 76, various types of operation elements and operation devices such as a keyboard, a mouse, a key, a dial, a touch panel, a touch pad, a remote controller, or the like are assumed.

An operation of the user U is detected by the input unit 76, and a signal corresponding to the input operation is interpreted by the CPU 71.

Furthermore, a display unit 77 including an LCD, an organic EL panel, or the like, and a voice output unit 78 including a speaker or the like are connected to the input/output interface 75 integrally or separately.

The display unit 77 is a display unit that performs various types of display, and includes, for example, a display device provided in a housing of a computer device, a separate display device connected to the computer device, or the like.

The display unit 77 executes display of an image for various types of image processing, a moving image to be processed, and the like on a display screen on the basis of an instruction from the CPU 71. Furthermore, the display unit 77 displays various types of operation menus, icons, messages, or the like, that is, displays as a graphical user interface (GUI) on the basis of the instruction from the CPU 71.

In some cases, the storage unit 79 including a hard disk, a solid-state memory, or the like, and a communication unit 80 including a modem or the like is connected to the input/output interface 75.

The communication unit 80 performs communication processing via a transmission path such as the Internet, wired/wireless communication with various devices, bus communication, and the like.

A drive 81 is also connected to the input/output interface 75 as necessary, and a removable storage medium 82 such as a magnetic disk, an optical disk, a magneto-optical disk, or a semiconductor memory is appropriately mounted.

A data file such as a program used for each processing can be read from the removable storage medium 82 by the drive 81. The read data file is stored in the storage unit 79, and images and voice included in the data file are output by the display unit 77 and the voice output unit 78. Furthermore, a computer program and the like read from the removable storage medium 82 are installed in the storage unit 79 as necessary.

In this computer device, for example, software for processing of the present embodiment can be installed via network communication by the communication unit 80 or the removable storage medium 82. Alternatively, the software may be stored in advance in the ROM 72, the storage unit 79, or the like.

As the CPU 71 performs processing operations on the basis of various programs, information processing and communication processing necessary for the server system 2 and the client system 3 including the arithmetic processing unit described above are executed.

Note that the information processing device is not limited to a single computer device as illustrated in FIG. 4 and may be configured by systematizing a plurality of computer devices. The plurality of computer devices may be systematized by a local area network (LAN) or the like, or may be disposed in a remote place by a virtual private network (VPN) or the like using the Internet or the like. The plurality of computer devices may include a computer device as a server group (cloud) that can be used by a cloud computing service.

### 3. First Embodiment

In a first embodiment, volume adjustment is performed on an environmental sound (a playing sound, a singing sound, a sound of an in-house broadcast, and the like) and an utterance voice in accordance with the degree of interest of the user U. Here, an example in which volume adjustment is performed on a playing sound as an example of the environmental sound and the utterance voice will be described.

Note that, in the present embodiment and each of the following embodiments, it is assumed that a user U for which audio reproduction is performed, in other words, a user U who is a listener is a first user U1, and an avatar AT corresponding to the first user U1 is a first avatar AT1.

Furthermore, it is assumed that another user U who is performing a voice chat with the first user U1 is a second user U2, and an avatar AT corresponding to the second user U2 is a second avatar AT2.

Several examples of the volume adjustment are conceivable. For example, in a case where it is determined that the interest in the playing sound is higher between the playing sound and the utterance voice, it is conceivable to make the playing sound easy to hear by raising the volume of the playing sound. Alternatively, it is conceivable to lower the volume of the utterance voice in order to relatively raise the volume of the playing sound. In this case, audio reproduction regarding the utterance voice is not necessarily performed by setting the volume of the utterance voice completely to zero.

Similarly, in a case where it is determined that the interest in the utterance voice is higher, the volume of the utterance voice may be raised, or the volume of the playing sound may be lowered to relatively raise the volume of the utterance voice.

By the way, there is a high possibility that the degree of interest for the playing sound varies depending on, for example, a piece of music being played. In this regard, the preference of music of the first user U1 is learned using machine learning, and the degree of interest of the first user U1 with respect to the playing sound of music being played is estimated using a learning result.

Such processing regarding the machine learning may be executed in the server system 2 or may be executed in the client system 3.

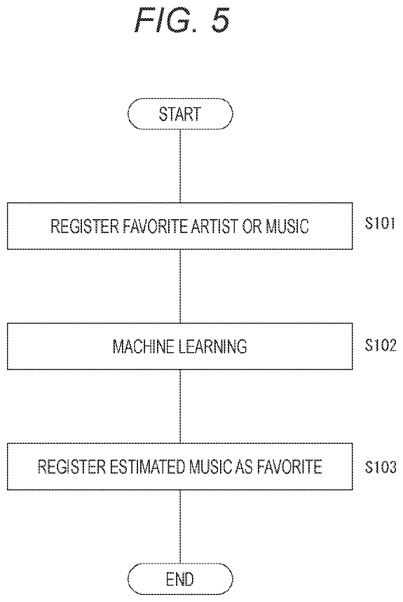

FIG. 5 illustrates a flow of processing related to machine learning.

The CPU 71 of the server system 2 or the CPU 71 of the client system 3 (hereinafter, simply referred to as a “control unit”) receives registration of a favorite artist or favorite music in step S101 of FIG. 5. This processing is executed in response to an operation of the first user U1.

In step S102, the control unit performs machine learning. In this processing, the control unit itself may perform machine learning using a learning model, or may perform machine learning by using a service provided in another information processing device and obtain the result.

In step S103, the control unit registers music in which the user U is estimated to be highly interested as a result of the machine learning as the favorite music. Note that processing of registering an artist in which interest is estimated to be high as a favorite artist may be performed in this processing.

By executing each processing of steps S101 to S103, the control unit can obtain the favorite information input by the first user U1 and favorite information estimated by the machine learning.

The client system 3 performs the above-described volume adjustment as emphasis control on the basis of the favorite information obtained in this manner.

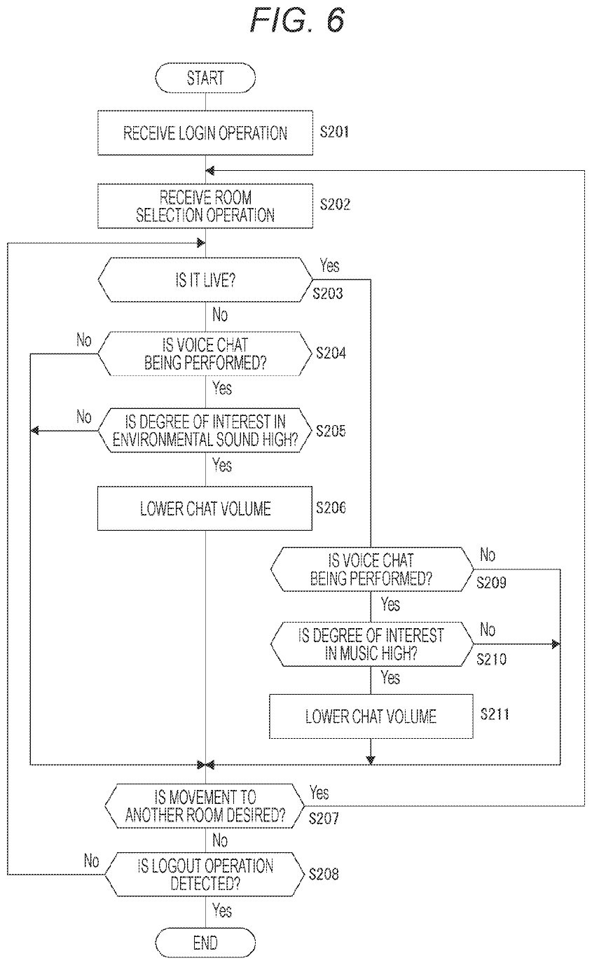

An example of a specific processing flow is illustrated in FIG. 6.

In step S201, the CPU 71 of the client system 3 receives a login operation performed by the first user U1 and transmits a login request to the server system 2.

The server system 2 receives the login request from the client system 3, determines whether or not login is permitted, and transmits the result to the client system 3.

As a result, the client system 3 executes processing of presenting a screen indicating that login has failed, a user screen after login, and the like to the first user U1.

Subsequently, in step S202, the CPU 71 of the client system 3 receives room selection processing, and transmits information specifying a selected room to the server system 2.

In a case where the number of people who can enter the room is not reached, the server system 2 permits entry to the room, and transmits the result to the client system 3. Note that the user U whose entry is to be permitted may be limited for each room.

As a result, the client system 3 executes processing of presenting a room screen after entry or the like to the first user U1. Specifically, processing is performed to present the virtual space VS in which three-dimensional objects such as a performer and a speaker and the avatars AT of every user U having entered the room are arranged via the HMD 10 of the first user U1.

In step 3203, the CPU 71 of the client system 3 performs processing of determining whether or not it is live. This processing may be executed as the client system 3 inquires the server system 2 of whether or not it is live, or the client system 3 may execute processing of determining whether or not it is live.

Note that the expression “it is live” indicates a state in which a start time of a concert in the virtual space VS has passed and music performance or the like is being performed.

In a case where it is determined that it is not live, that is, in a case where it is before the start time of the concert or in a case where it is after an end time of the concert, the CPU 71 of the client system 3 determines whether or not the voice chat is being performed in step S204.

The expression “the voice chat is being performed” here corresponds to a case where a one-to-one voice chat is being performed between the first user U1 and the second user U2, a case where a voice chat other than the one-to-one voice chat is being performed between the users U having the avatars AT arranged in the room, or the like.

For example, it is determined that the voice chat is being performed in a case where audio as an utterance voice by any user U is being reproduced for the first user U1. Alternatively, it may be determined that the voice chat is being performed if the microphone 25 of the client system 3 used by the first user U1 is in a state of picking up the utterance voice of the first user U1.

In a case where it is determined that the voice chat is being performed, the CPU 71 of the client system 3 determines whether or not the degree of interest in the environmental sound is high in step S205. Note that, since it is not live, the environmental sound here is audio of an in-house broadcast, audio of an announcement of a product sale, or the like.

In a case where it is determined that the degree of interest in the environmental sound is high, the CPU 71 of the client system 3 performs processing of lowering the chat volume of the voice chat in step S206.

Alternatively, processing of raising the volume of the environmental sound may be performed.

After the processing of lowering the chat volume is performed, after it is determined in step S204 that the voice chat is not being performed, or after it is determined in step S205 that the degree of interest in the environmental sound is not high, the CPU 71 of the client system 3 determines in step S207 whether or not to move to another room.

The determination as to whether or not to move to another room is made on the basis of whether or not a room moving operation performed by the user U is detected.

In a case where it is determined to move to another room, the CPU 71 of the client system 3 returns to the processing of step S202.

On the other hand, in a case where the operation for moving to another room is not detected, the CPU 71 of the client system 3 proceeds to step S208 and determines whether or not a logout operation is detected. In a case where the logout operation is detected, the CPU 71 of the client system 3 ends a series of processing illustrated in FIG. 6.

In a case where the logout operation is not detected in step S208, the CPU 71 of the client system 3 returns to step S203.

The description returns to step S203. In a case where it is determined in step S203 that it is live, the CPU 71 of the client system 3 determines in step S209 whether or not the voice chat is being performed.

This determination processing may be performed, for example, on the basis of whether or not the utterance voice of the first user U1 is input to the microphone 25 of the client system 3. Meanwhile, there is also a possibility that the first user U1 is humming the music being played. In this regard, in the determination processing of step S209, whether or not the voice of the first user U1 input to the microphone 25 is uttered by singing may be further determined to determine whether or not the voice chat is being performed.

In a case where it is determined that the voice chat is being performed, it is estimated that the first user U1 is in a state of hearing both the playing sound and the utterance voice.

In step S210, the CPU 71 of the client system 3 performs processing of determining whether or not the music being played is music with a high degree of interest.

For example, the determination may be made by performing matching between the music registered in advance and the music being played, or the similarity between a feature of the registered music or a feature of a registered rhythm and a feature of the music being played may be determined to determine the music similar to the registered music is also determined to be the music with a high degree of interest. In this case, a level of the degree of interest may be calculated using deep learning.

Alternatively, there may be a case where it is determined that the degree of interest in the playing sound is relatively high since the degree of interest in the voice chat is low.

Moreover, an action of the first user U1 may be detected to determine whether or not the degree of interest in the music being played is high. For example, it may be determined that the degree of interest in the music is low in a case where the first user U1 faces downward or in a case where the first user U1 faces a place different from the performer.

In a case where it is determined that the degree of interest in the music is high, the CPU 71 of the client system 3 performs processing of lowering the chat volume of the voice chat or raising the volume of the playing sound in step S211, and proceeds to processing of step S207.

Furthermore, also in a case where it is determined in step S209 that the voice chat is not being performed or in a case where it is determined in step S210 that the degree of interest in the music is not high, the CPU 71 of the client system 3 proceeds to the processing in step S207.

That is, the CPU 71 of the client system 3 executes processing of performing volume adjustment as needed by estimating the degree of interest in each of the environmental sound and the utterance voice while determining if it is live and if the voice chat is being performed by executing the processing illustrated in FIG. 6 as long as the first user U1 has entered the current room without performing the logout operation.

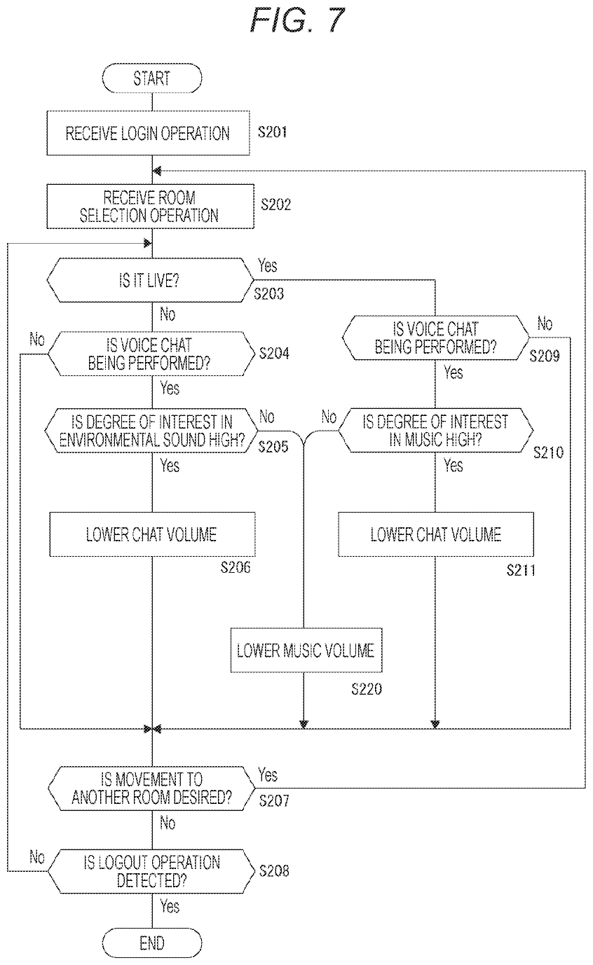

FIG. 6 illustrates an example in which the emphasis control based on the degree of interest of the user U is performed by lowering the volume of the voice chat. Another example is illustrated in FIG. 7.

Note that processing similar to that in FIG. 6 is denoted by the same step number, and description thereof is omitted as appropriate.

Each processing from step S201 to step S211 is configured as similar processing.

A difference from the example illustrated in FIG. 6 is that the CPU 71 of the client system 3 performs processing of lowering the volume of the environmental sound (audio of the playing sound or the in-house broadcast) in step S220 in a case where it is determined in step S205 that the degree of interest in the environmental sound is low or in a case where it is determined in step 3210 that the degree of interest in the music being played is low.

In the example illustrated in FIG. 7, the processing of lowering the volume of the environmental sound is performed to make it easy to listen to the voice chat and to allow smooth communication although emphasis control is not performed in FIG. 6.

### 4. Second Embodiment

A second embodiment is an example in which a voice chat on which emphasis control is to be performed is limited to a voice chat with a specific user U.

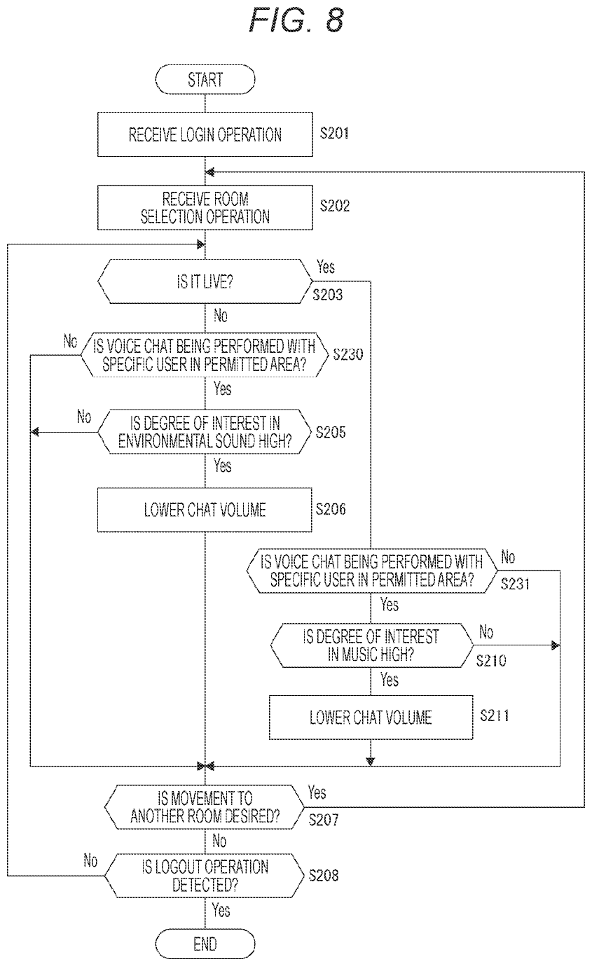

A specific processing flow will be described with reference to FIG. 8. Note that processing similar to that in FIG. 6 is denoted by the same step number, and description thereof is omitted as appropriate.

The CPU 71 of the client system 3 receives a login operation in step S201, receives a room selection operation in step S202, and then, determines whether or not it is live in step S203.

In a case where it is determined that it is live, the CPU 71 of the client system 3 determines in step S230 whether or not the voice chat with the specific user U is being performed in a permitted area for the voice chat.

Here, the permitted area will be described.

The permitted area in which voice chat is permitted and a non-permitted area in which the voice chat is not permitted are provided in a room as the virtual space VS in which the first avatar AT1 of the first user U1 is arranged.

The permitted area is an area where a user U (avatar AT) who desires to enjoy a concert while performing a voice chat moves to come.

On the other hand, the non-permitted area is an area where a user U (avatar AT) who desires to concentrate on and enjoy the concert without being disturbed by a voice chat moves to come.

Therefore, in the present example, in a case where the avatar AT associated with the user U is located in the non-permitted area, the volume of the voice chat is always set to zero.

Here, various methods are conceivable to determine whether the first avatar AT1 associated with the first user U1 is located in the permitted area or the non-permitted area. For example, the determination may be made on the basis of a floor object with which a foot of the first avatar AT1 is in contact.

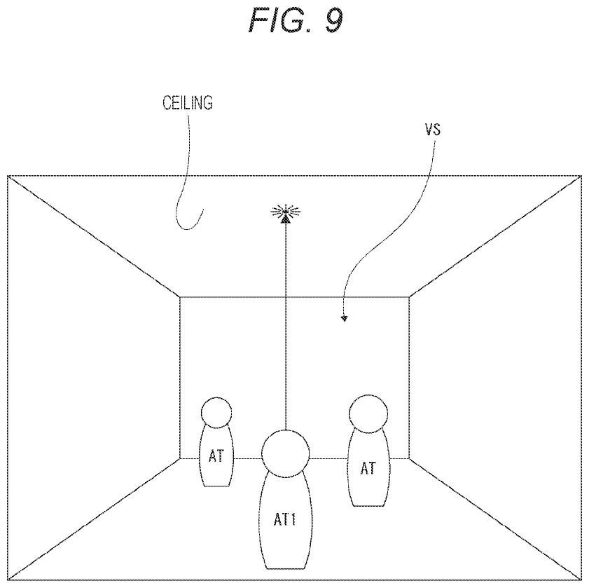

Alternatively, as illustrated in FIG. 9, a type of area may be determined by emitting a virtual light beam upward from the top of a head of the first avatar AT1 and determining the ceiling with which the light beam collides.

Alternatively, the type of area may be determined in accordance with a coordinate position of the first avatar AT1 in a three-dimensional space.

Furthermore, the specific user U is the second user U2 who is another user designated by the first user U1. In other words, the second embodiment is an example in which, in a case where there is a specific second user U2 with which the first user U1 desires to perform a voice chat, a voice chat with the other user U is not likely to be subjected to emphasis control and the voice chat with the second user U2 may be subjected to emphasis control.

Several methods used for the first user U1 to designate a user U are conceivable.

For example, the first user U1 may designate a name or an ID of the second user U2 by inputting characters, or may perform the designation by performing a pointing motion such as a movement of touching the second avatar AT2 associated with the second user U2, a motion of pointing out with a finger, or a motion of directing a face or a line of sight to the second avatar AT2.

In a case where it is determined in step S230 that the first user U1 is performing the voice chat with the specific user U in the chat permitted area, the CPU 71 of the client system 3 determines in step S205 whether or not the interest in the environmental sound is high, and performs processing of lowering the volume of the voice chat with the second user U2 in step S206 in a case where the interest in the environmental sound is high.

Note that FIG. 8 illustrates an example in which the processing proceeds to step S207 without performing anything in a case where the interest in the environmental sound is low in step S205, but emphasis control for raising the volume of the voice chat with the second user U2 may be performed in a case where the interest in the environmental sound is low.

Furthermore, in a case where it is determined in step S203 that it is live, the CPU 71 of the client system 3 determines in step S231 whether or not the voice chat is being performed with the specific second user U2 in the permitted area.

In a case where it is determined that the voice chat is being performed with the second user U2 who is the specific user U in the permitted area, the CPU 71 of the client system 3 determines whether or not the degree of interest in a music being played is high in step S210, and performs processing of lowering the volume of the voice chat with the second user U2 in step S211 in a case where it is determined that the degree of interest in the music is high.

Note that emphasis control for raising the volume of the voice chat with the second user U2 may be performed in a case where it is determined in step S210 that the degree of interest in the music is low.

### 5. Third Embodiment

In a third embodiment, an example in which an utterance voice is converted into text and presented to the first user U1 will be described.

Several methods are conceivable to convert an utterance voice into text information and presenting the text information to the first user U1. For example, it is conceivable to provide a chat field in an image to be visually recognized by the first user U1 and display text information in the chat field.

Alternatively, a method of arranging character information converted into a three-dimensional object in the virtual space VS is also conceivable.

FIG. 10 illustrates an example of the three-dimensional object obtained by converting the character information.

The character information converted into the three-dimensional object is arranged in the virtual space VS as three-dimensional text TX. At this time, the three-dimensional text TX accompanied by an effect EF may be generated such that an utterer is known.

For example, the effect EF indicating that the three-dimensional text TX pops up from the second avatar AT2 associated with the second user U2 such that the utterer can be recognized as the second user U2 is arranged in the example illustrated in FIG. 10.

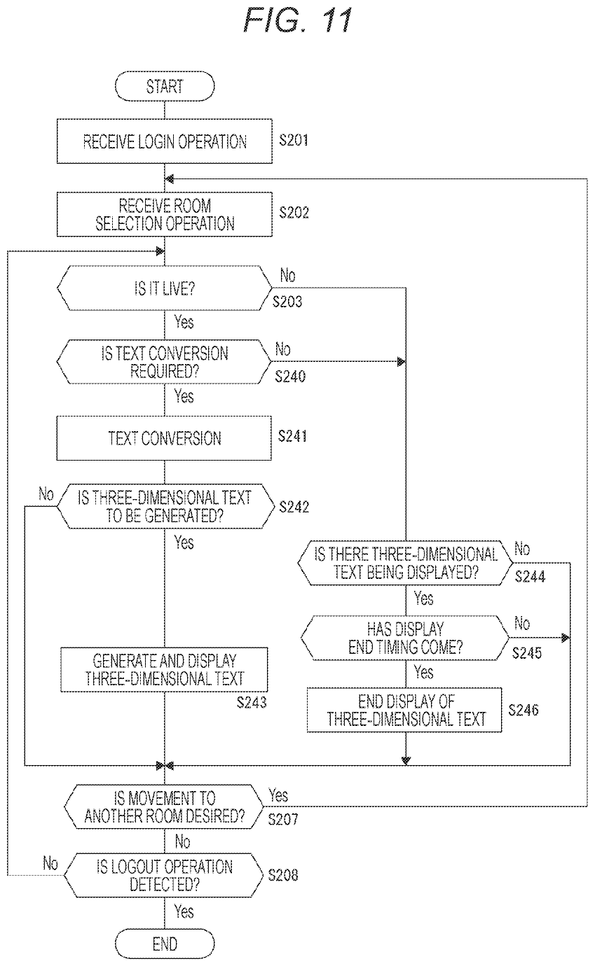

A specific processing flow in the third embodiment will be described with reference to FIG. 11. Note that processing similar to processing illustrated in FIG. 6 will be denoted by the same step number, and description thereof will be omitted as appropriate.

The CPU 71 of the client system 3 receives a login operation in step S201, receives a room selection operation in step S202, and then, determines whether or not it is live in step S203.

Then, in a case where it is determined that it is live, the CPU 71 of the client system 3 determines in step S240 whether or not text conversion of a voice chat (utterance voice) is required.

This determination processing is performed, for example, on the basis of the volume of a playing sound of a concert or the volume of the voice chat. Specifically, it is determined that the text conversion is required in a case where the playing sound is a predetermined value or more or in a case where the volume of the voice chat is less than a predetermined value.

Furthermore, it may be determined that the text conversion is required in a case where the degree of interest in an environmental sound (the playing sound) is high and the volume of the utterance voice is desirably set to zero or in a case where it is not desired to raise the volume of the utterance voice.

In a case where the text conversion is required, the CPU 71 of the client system 3 performs text conversion processing on the voice chat in step S241. At this time, only a voice chat with the specific second user U2 may be subjected to the text conversion as in the second embodiment.

Subsequently, in step S242, the CPU 71 of the client system 3 determines whether or not to generate the three-dimensional text TX by subjecting text to conversion into a three-dimensional object.

A case where the conversion into a three-dimensional object is performed includes, for example, a case where the first user U1 does not pay attention to the chat field, a case where the chat field is not gazed, and the like. Furthermore, it may be determined to generate the three-dimensional text TX in a case where a visual field of the first user U1 is not hindered even if the three-dimensional text TX is arranged in the virtual space VS, or it may be determined to generate the three-dimensional text TX in a case where only the degree of interest in audio of the first user U1 is high and the degree of interest in a three-dimensional object such as a performer displayed on the display unit 23 is low.

In a case where it is determined to generate the three-dimensional text TX, the CPU 71 of the client system 3 performs processing of generating and displaying the three-dimensional text TX in step S243. Specifically, processing of arranging the three-dimensional text TX at a predetermined position is performed. As this processing is performed, the virtual space VS in which the three-dimensional text TX has been arranged is displayed on the display unit 23 of the HMD 10 worn by the first user U1.

After the processing of step S243 is finished, the CPU 71 of the client system 3 proceeds to the processing of step S207.

In a case where it is determined in step 3203 that it is not live or in a case where it is determined in step S204 that the text conversion is not required, the CPU 71 of the client system 3 proceeds to processing of step S244.

In the processing of step S244, the CPU 71 of the client system 3 determines whether or not there is the three-dimensional text TX being displayed. In a case where the three-dimensional text TX remains arranged in the virtual space VS, the number of three-dimensional objects increases, and there is a possibility that the visual field of the first user U1 is hindered and it becomes difficult to visually recognize the three-dimensional object such as the performer. In this regard, processing is performed to end the display of the three-dimensional text TX at an appropriate timing in the present embodiment.

In a case where it is determined that there is the three-dimensional text TX being displayed, the CPU 71 of the client system 3 determines whether or not a display end timing has come for every three-dimensional text TX in step S245.

Several examples of the display end timing will be described.

For example, it may be determined that the display end timing has come in a case where an elapsed time from a start of display exceeds a predetermined time.

Alternatively, it may be determined that the display end timing has come when a predetermined operation is performed by the first user U1. Since the first user U1 can end the display of the three-dimensional text TX by his/her operation, it is possible to leave only a message that is desirably left or to delete an unnecessary message fast, which is highly convenient. Furthermore, by providing a configuration in which the three-dimensional text TX can also be visually recognized by the second user U2 who is the utterer, the second user U2 can recognize that a message content has been reliably delivered to the first user U1 in a case where the display of the three-dimensional text TX is ended by the operation of the first user U1, which also improves the convenience.

Furthermore, as another example of the display end timing, it may be determined that the display end timing has come when the three-dimensional text TX collides with another three-dimensional object (including another three-dimensional text TX).

According to this example, the probability of the collision with another three-dimensional object increases as the number of pieces of the three-dimensional text TX increases, so that the display end timing of the three-dimensional text TX appropriately comes. Note that, in this case, it may be configured such that it is not determined as the display end timing even if the collision with another three-dimensional object occurs for a certain period of time after the start of the display of the three-dimensional text TX. As a result, it is possible to prevent the display from ending in an extremely short time.

The description returns to FIG. 11.

In a case where there is the three-dimensional text TX for which the display end timing has come in step S245, the CPU 71 of the client system 3 performs processing of ending the display of the corresponding three-dimensional text TX in step S246.

The CPU 71 of the client system 3 proceeds to the processing of step S207 in a case where it is determined in step S244 that there is no three-dimensional text TX being displayed, in a case where it is determined in step S245 that the display end timing has not come for any three-dimensional text TX, or after the processing of step S246 is finished.

Conversion into text may be performed in a case where the utterance voice (voice chat) is of high interest, which is different from the above-described example. For example, in a case where the degree of interest in the utterance voice is high and it is desired to prevent missing of the utterance voice, it is possible to deliver a content of the voice chat to the first user U1 using both a visual sense and an auditory sense by displaying three-dimensional text as well as performing audio reproduction regarding the utterance voice.

### 6. Fourth Embodiment

A fourth embodiment is an example of a case where the first user U1 is interested in an utterance voice.

Specifically, emphasis control is performed on a conversation partner (utterer), for example, in a case where the first user U1 has a high degree of interest in a voice chat but does not know who the first user U1 is talking with and the like.

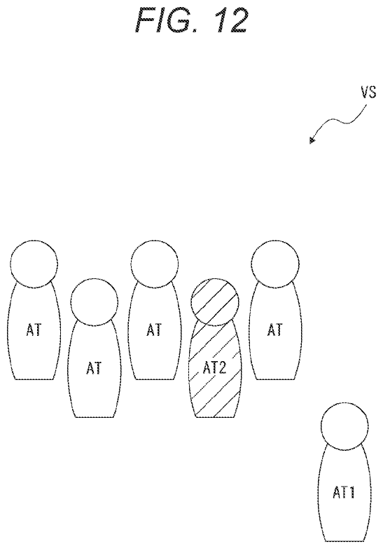

In a first example in the present embodiment, visual emphasis control is performed on the utterer. Specifically, processing of changing a display color of the second avatar AT2 associated with the second user U2 who is the utterer (see FIG. 12), processing of emphasizing a contour of the second avatar AT2 by blinking or the like, processing of increasing a size of the second avatar AT2, or the like is performed.

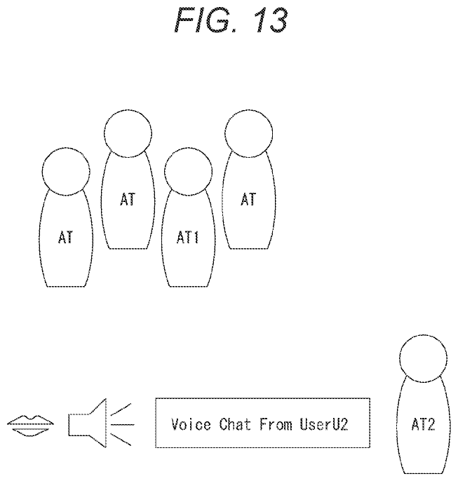

In a second example, an icon is displayed to provide notification that there is receipt of the voice chat from the second user U2 who is the utterer or that there is a voice chat start request (see FIG. 13).

The first example and the second example can be said to be examples in which the visual emphasis control is performed.

In a third example, processing is performed to move the second avatar AT2 of the second user U2 who is the utterer close to the first avatar AT1 of the first user U1 in a pseudo manner.

For example, each of the first user U1 and the second user U2 locates the avatar AT in the virtual space VS such that the audio reproduction is optimal for himself/herself. Therefore, there is a case where the first avatar AT1 and the second avatar AT2 are distant from each other.

In a case where attenuation processing in accordance with a distance is performed in the audio reproduction when the second user U2 speaks to the first user U1 in this state, the utterance voice of the second user U2 is too quiet, and there is a case where the first user U1 does not notice the utterance voice or a case where the first user U1 cannot hear the utterance voice.

In this regard, it is conceivable to move the second avatar AT2 associated with the second user U2 close to the first avatar AT1 or vice versa, but a listening position is no longer optimal for each of the users U in such a case.

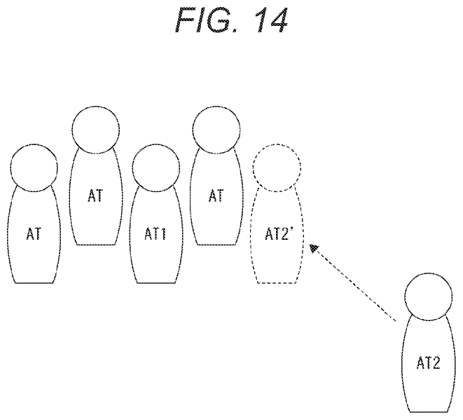

In the third example, processing is performed to move a position of the second avatar AT2 close to AT1 (a position of a second avatar AT2′ in FIG. 14) in a pseudo manner. In this moving processing, only the position of the second avatar AT2 as an utterance position is moved, and a position of the second avatar AT2 as a listening position set by the second user U2 who desires to enjoy a concert is not changed.

Therefore, the first user U1 can easily hear an utterance content of the second user U2, and the second user U2 can enjoy the concert at the optimum listening position.

The third example can be said to be auditory emphasis control, but can also be said to be visual emphasis control since a display position of the second user U2 is changed from the viewpoint of the first user U1.

In a fourth example, the vibration unit 31 included in the hand controller 11 worn by the first user U1 may be vibrated to provide notification that there is receipt of the voice chat or the voice chat start request from the specific user U.

Note that a similar effect may be obtained by vibrating a vibration unit of the HMD 10 in a case where the HMD 10 includes the vibration unit.

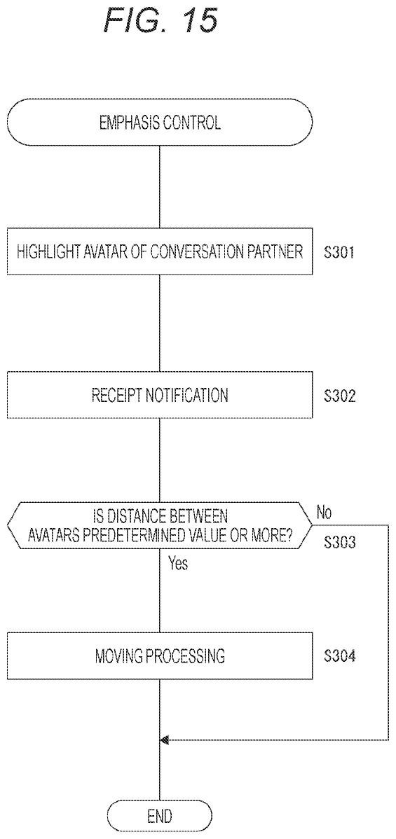

A flow of processing in a case where all of the first example, the second example, and the third example described above are executed will be described with reference to FIG. 15.

Note that some of processing illustrated in FIG. 15 is not necessarily executed.

In step S301 of FIG. 15, the CPU 71 of the client system 3 highlights the avatar AT of the conversation partner (see FIG. 12).

Moreover, in step S302, the CPU 71 of the client system 3 performs the text display and icon display as illustrated in FIG. 13 to provide notification of the receipt.

In addition, the CPU 71 of the client system 3 determines in step S303 whether or not the distance between the avatars AT is a predetermined value or more, and performs the pseudo moving processing of the avatar AT (see FIG. 14) in step S304 in a case where it is determined that the distance is the predetermined value or more.

On the other hand, in a case where it is determined that the distance between the avatars AT is less than the predetermined value, the CPU 71 of the client system 3 ends the series of processing illustrated in FIG. 15 without executing the processing of step S304.

### 7. Modifications

In a case where determination as to whether or not it is live (for example, the processing of step S203 in FIG. 6) is performed, the determination may be performed using various types of metadata.

The metadata includes, for example, information regarding music being played, information such as a timetable indicating a progress status, information for specifying an environmental sound being reproduced, and the like. The use of these pieces of information makes it possible to specify what kind of audio is being reproduced, and it is possible to determine whether or not it is live.

In the examples described above, the user U wears the HMD 10 and the hand controller 11, but the user U may enjoy a concert or the like in a state of gripping a smartphone, a tablet terminal, or the like.

In a case where a smartphone is used, an image to be displayed on a display unit of the smartphone is created by a control unit of the smartphone using a 3-degrees-of-freedom (3DoF) or 6DoF sensing function and a simultaneous localization and mapping (SLAM) function included in the smartphone.

Then, an orientation of a face of the user U is replaced with an orientation of a screen of the smartphone to display the image appropriately for the orientation of the screen on the screen of the smartphone.

Although a case where the utterance voice uttered by the second user U2 is delivered to the first user U1 in substantially real time has been described in the examples described above, the utterance voice may be buffered in a case where the volume of the environmental sound is a certain value or more. Then, the buffered utterance voice may be presented to the first user U1 in a case where the volume of the environmental sound is less than the certain value.

Furthermore, at this time, the utterance voice may be reproduced as audio, or may be presented as text.

In the case of being presented as text, conversion into the text may be performed at the time of buffering, and in this case, the amount of data required for buffering can be reduced.

The above-described technology can be widely applied to events in which communication by a voice chat is performed, such as remote education, training, a remote conference, remote work support, and shopping, in addition to the concert in which the respective users U participate remotely.

### 8. Summary

As described in each of the examples described above, the client system 3 as an information processing device includes the emphasis information generation unit 21 that generates control information for performing emphasis control on audio in the virtual space VS on the basis of interest information of the first user U1 associated with the first avatar AT1 arranged in the virtual space VS. Furthermore, the audio includes an environmental sound such as a playing sound in the virtual space VS and an utterance voice of the second user U2 associated with the second avatar AT2 arranged in the virtual space VS. In other words, the environmental sound referred to here is audio generated in the virtual space VS except for the utterance voice by the user U.

The interest information is interest information related to audio. Then, the audio includes the environmental sound, the utterance voice, and the like. The environmental sound is a sound generated in the virtual space VS, for example, a playing sound in a music concert, an announcement broadcast sound for conveying a start of performance, a voice emitted by a performer, or the like. Furthermore, the utterance voice includes voices uttered by viewers and the like.

Each of the viewers can experience the audio in accordance with a position of the avatar AT arranged as his/her own virtual self in the virtual space VS.

The information processing device generates control information for performing emphasis control on either the environmental sound or the utterance voice or control information for performing emphasis control on the both on the basis of the interest information of the first user U1.

As a result, the emphasis control on music is performed in a case where the first user U1 is interested in the music of the concert, and the emphasis control on the utterance voice is performed in a case where the first user U1 is interested in the utterance voice of the second user U2.

Therefore, the first user U1 can experience an appropriate audio output in accordance with his/her interest.

As described above, the interest information may be information indicating the degree of interest in the environmental sound.

Since the emphasis control of the audio is performed on the basis of information of the degree of interest of the first user U1 regarding the environmental sound, for example, control for lowering the volume of a voice chat or control for raising the volume of the environmental sound (playing sound) is performed while the music or the like that the first user U1 desires to view and hear without any hindrance is being played.

As a result, it is possible to enhance a sense of immersion in a concert performance or the like and to enjoy the music or the like.

As described with reference to FIG. 3 and the like, the information indicating the degree of interest may be information obtained by a pointing motion of the first user U1.

For example, it is determined that the environmental sound (playing sound) is of high interest in a case where the first user U1 has performed the pointing motion to point to the avatar AT0 of the performer or the like, and it is determined that the utterance voice, that is, the voice chat is of high interest in a case where the first user U1 performs a pointing motion to point to the avatar AT of another user U such as the second user U2 or the like.

As a result, the first user U1 can appropriately designate a target of high interest, and can experience the audio output by raising the volume of the audio in which the first user U1 is highly interested.

Furthermore, since the target of high interest is appropriately pointed by the first user U1, it is possible to prevent audio different from an intention of the first user U1 from being emphasized.

As described with reference to FIG. 6 and the like, the emphasis control executed by the client system 3 may be control for changing the volume of audio to be controlled.

For example, control for raising the volume or the like is executed with the audio of high interest as a target to be controlled.

As a result, it is possible to concentrate on the concert or the like since a preferred sound is relatively increased by raising the volume of the audio of high interest to the first user U1 or lowering the volume of the audio of low interest to the first user U1, and thus, it is possible to enhance the sense of immersion.

As described with reference to FIG. 11 and the like, the emphasis information generation unit 21 of the client system 3 may include the text conversion unit 18 that converts the utterance voice of the second user U2 into text.

As a result, control is performed to convert an utterance voice of high interest into text and convert an utterance voice of low interest into text.

Specifically, the following configuration can be adopted as described with reference to FIG. 11 and the like.

The text conversion unit 18 of the client system 3 may convert the utterance voice of the second user U2 into text in a case where the degree of interest in the environmental sound is high.

For example, the utterance voice of high interest is converted into text and presented to the first user U1, and thus, it is possible to prevent the first user U1 from missing the voice chat with the second user U2.

Furthermore, the following configuration can also be adopted as described in the third embodiment.

The text conversion unit 18 of the client system 3 may convert the utterance voice of the second user U2 into text in a case where the degree of interest in the utterance voice is high.

For example, the utterance voice of low interest is converted into text and presented to the first user U1, and thus, the voice chat of the second user U2 can be delivered to the first user U1 without disturbing the first user U1 concentrating on the environmental sound such as the playing sound.

As described with reference to FIG. 11 and the like, the text conversion unit 18 of the client system 3 may perform processing of further converting the converted text into three-dimensional character information.

For example, the text converted from the utterance voice is presented to the first user U1 as a three-dimensional object that is the three-dimensional text information.

As a result, the first user U1 to which the second user U2 who is an utterer has spoken can appropriately grasp an utterance content of the second user U2.

Furthermore, as described above, the display control unit 14 that determines a display end timing for a three-dimensional object based on the three-dimensional character information may be provided.

Continuing to display the three-dimensional object is likely to be a barrier when the first user U1 visually recognizes the performer or the like. Furthermore, when the three-dimensional object is continuously displayed, a plurality of the three-dimensional objects based on the voice chat is displayed, which may be an obstacle to a visual sense of the first user U1 with respect to the surroundings.

According to this configuration, the display end timing is determined for each of the three-dimensional objects, and thus, it is possible to ensure the visibility of the first user U1 in the virtual space VS.

As described above, the display control unit 14 may determine a timing after a lapse of a predetermined time from a start of display of the three-dimensional object as the display end timing.

When the display of the three-dimensional object is ended in accordance with the lapse of the predetermined time, it is possible to prevent an excessive increase in the number of three-dimensional objects being displayed.

As a result, the three-dimensional object is prevented from being an obstacle that blocks a visual field of the first user U1, and a good visual field of the first user U1 can be ensured.

As described above, the display control unit 14 may determine a timing at which a predetermined operation is performed on the three-dimensional object as the display end timing.

When a display end operation for the three-dimensional object is provided, it is possible to end display of any three-dimensional object.

As a result, each of the users U such as the first user U1 and the second user U2 can manually prevent display of an unnecessary three-dimensional object based on the voice chat, and convenience can be improved.

In particular, the second user U2 who is the utterer of the voice chat can manually delete an erroneous chat input or the like. Furthermore, the first user U1 who is a recipient of the voice chat can cause only a necessary three-dimensional object to remain displayed.

Note that the user U who can execute the operation of ending the display of the three-dimensional object may be limited as described above. For example, only the first user U1 may be allowed to perform the operation of ending the display regarding a three-dimensional object based on the voice chat by the utterance of the second user U2. As a result, in a case where the display of the three-dimensional object is manually ended, the second user U2 can recognize that the first user U1 has confirmed a content of the chat. This makes it possible to achieve smooth communication.

As described with reference to FIG. 11 and the like, the display control unit 14 of the client system 3 may determine a timing at which three-dimensional text as a three-dimensional object collides with another object arranged in the virtual space VS as a display end timing of the three-dimensional text.

When the number of the three-dimensional objects arranged in the virtual space VS is too large, the collision between the three-dimensional objects is likely to occur. Therefore, when the display of the three-dimensional object is ended based on the collision, the number of the three-dimensional objects arranged in the virtual space VS is prevented from being too large.

As a result, it is possible to prevent a field of view of the user U in the virtual space VS from being obstructed by the three-dimensional object, and to ensure the field of view.

As described with reference to FIGS. 12 and 13 and the like, the emphasis information generation unit 21 of the client system 3 may generate control information for performing visual emphasis control on the basis of the interest information.

In the virtual space VS, the first user U1 is sometimes not able to grasp a position of another user U such as the second user U2 who has emitted the utterance voice, and to know from whom the voice chat has arrived.

According to this configuration, it is possible to perform the visual emphasis control for such another user U.

As a result, the first user U1 can grasp a partner of the voice chat, and can perform appropriate communication.

As described with reference to FIG. 12 and the like, the visual emphasis control may be control for performing visual emphasis on the second avatar AT2 in a case where the utterance voice of the second user U2 is of high interest.

This facilitates the first user U1 to visually recognize the second avatar AT2 associated with the second user U2 who has performed the voice chat.

Therefore, it is possible to grasp the user U as the partner of the voice chat.

As described with reference to FIG. 13 and the like, the visual emphasis control may be control for displaying text to provide notification of the utterance of the second user U2 in a case where the utterance voice of the second user U2 is of high interest.

As a result, the first user U1 can specify the user U who has performed the voice chat.

Therefore, appropriate communication can be performed.

As described with reference to FIG. 14 and the like, the emphasis control may be control for changing an utterance position of the utterance voice of the second user U2 in the virtual space VS in a case where the utterance voice of the second user U2 is of high interest.

As a result, the second avatar AT2 associated with the second user U2 who is the partner of the voice chat is located close to the first avatar AT1.

Therefore, the first user U1 can easily hear the utterance voice of the second user U2 in a case where three-dimensional audio (stereophonic audio) is reproduced in accordance with the mutual positional relationship in the virtual space VS, and thus, appropriate communication can be performed.

As described with reference to FIG. 3 and the like, the client system 3 as the information processing device may include the area determination unit 20 that determines whether or not a position of the avatar AT in the virtual space VS is within a permitted area where the voice chat is permitted.

For example, the permitted area in which the voice chat can be performed and a non-permitted area in which the voice chat cannot be performed are provided in the virtual space VS.

As a result, it is possible to concentrate on the concert without performing the voice chat by moving to the non-permitted area. Furthermore, communication with another user U through the voice chat can be performed by moving to the permitted area.

As described with reference to FIG. 8 and the like, the emphasis information generation unit 21 of the client system 3 may generate control information for performing emphasis control on the utterance voice in a case where the first avatar AT1 is located in the permitted area.

For example, it is possible to adopt a configuration in which emphasis control regarding the utterance voice is not performed at a location in the non-permitted area, and the emphasis control is performed at a location in the permitted area.

As a result, the emphasis control regarding the utterance voice is performed on the user U who has moved to the permitted area with a desire to perform the voice chat, and thus, appropriate control can be performed.

Furthermore, since the emphasis control regarding the utterance voice is not performed in a case where the user U is located in the non-permitted area, the concentration of the user U on the concert or the like is not impaired.

An information processing method in the present technology is executed by a computer device, and includes generating control information for performing emphasis control on audio including an environmental sound in the virtual space VS and an utterance voice of the second user U2 associated with the second avatar AT2 arranged in the virtual space VS on the basis of interest information of the first user U1 associated with the first avatar AT1 arranged in the virtual space VS.

A storage medium in the present technology can be read by a computer device storing a program for causing an arithmetic processing device to execute a function of generating control information for performing emphasis control on audio including an environmental sound in the virtual space VS and an utterance voice of the second user U2 associated with the second avatar AT2 arranged in the virtual space VS on the basis of interest information of the first user U1 associated with the first avatar AT1 arranged in the virtual space VS.

A program to be executed by the client system 3 as an information processing device is a program that causes an arithmetic processing device such as a CPU included in the client system 3 to execute a function of generating control information for performing emphasis control on audio including an environmental sound in the virtual space VS and an utterance voice of the second user U2 associated with the second avatar AT2 arranged in the virtual space VS on the basis of interest information of the first user U1 associated with the first avatar AT1 arranged in the virtual space VS.

With such a program, the above-described emphasis control regarding the audio can be realized by the arithmetic processing device such as a microcomputer.

Such programs can be recorded in advance in a hard disk drive (HDD) as a recording medium built in a device such as a computer device, a ROM in a microcomputer having a CPU, or the like. Alternatively, the program can be temporarily or permanently stored (recorded) in a removable recording medium such as a flexible disk, a compact disk read only memory (CD-ROM), a magneto optical (MO) disk, a digital versatile disc (DVD), a Blu-ray disc (registered trademark), a magnetic disk, a semiconductor memory, or a memory card. Such a removable recording medium can be provided as so-called package software.

Furthermore, such a program may be installed from the removable recording medium into a personal computer or the like, or may be downloaded from a download site via a network such as a local area network (LAN) or the Internet.

Note that the effects described in the present specification are merely illustrative and are not limited, and other effects may be exerted.

Furthermore, the above-described respective examples may be combined in any way, and the above-described various functions and effects may be obtained even in a case where various combinations are used.

### 9. Present Technology

The present technology can also adopt the following configurations.

(1)

An information processing device including
an emphasis information generation unit that generates control information for performing emphasis control on audio including an environmental sound in a virtual space and an utterance voice of a second user associated with a second avatar arranged in the virtual space on the basis of interest information of a first user associated with a first avatar arranged in the virtual space.

(2)

The information processing device according to (1), in which
the interest information is information indicating a degree of interest in the environmental sound.

(3)

The information processing device according to (2), in which
the information indicating the degree of interest is information obtained by a pointing motion of the first user.

(4)

The information processing device according to any one of (1) to (3), in which
the emphasis control is control for changing the volume of audio to be controlled.

(5)

The information processing device according to any one of (1) to (4), in which
the emphasis information generation unit includes a text conversion unit that converts the utterance voice of the second user into text.

(6)

The information processing device according to (5), in which
the text conversion unit converts the utterance voice of the second user into the text in a case where the degree of interest in the environmental sound is high.

(7)

The information processing device according to (5), in which
the text conversion unit converts the utterance voice of the second user into the text in a case where a degree of interest in the utterance voice is high.

(8)

The information processing device according to any one of (5) to (7), in which
the text conversion unit performs processing of further converting the converted text into three-dimensional character information.

(9)

The information processing device according to (8), further including
a display control unit that determines a display end timing for a three-dimensional object based on the three-dimensional character information.

(10)

The information processing device according to (9), in which
the display control unit determines a timing after a lapse of a predetermined time from a start of display of the three-dimensional object as the display end timing.

(11)

The information processing device according to (9), in which
the display control unit determines a timing at which a predetermined operation is performed on the three-dimensional object as the display end timing.

(12)

The information processing device according to (9), in which
the display control unit determines a timing at which the three-dimensional object collides with another object arranged in the virtual space as the display end timing.

(13)

The information processing device according to any one of (1) to (12), in which
the emphasis information generation unit generates control information for performing visual emphasis control on the basis of the interest information.

(14)

The information processing device according to (13), in which
the visual emphasis control is control for performing visual emphasis on the second avatar in a case where the utterance voice of the second user is of high interest.

(15)

The information processing device according to (13), in which
the visual emphasis control is control for displaying text to provide notification of an utterance of the second user in a case where the utterance voice of the second user is of high interest.

(16)

The information processing device according to any one of (1) to (15), in which
the emphasis control is control for changing an utterance position of the utterance voice of the second user in the virtual space in a case where the utterance voice of the second user is of high interest.

(17)

The information processing device according to any one of (1) to (16), further including
an area determination unit that determines whether or not an avatar position in the virtual space is within a permitted area where a voice chat is permitted.

(18)

The information processing device according to (17), in which
the emphasis information generation unit generates control information for performing emphasis control on the utterance voice in a case where the first avatar is located in the permitted area.

(19)

An information processing method for causing a computer device to execute
processing of generating control information for performing emphasis control on audio including an environmental sound in a virtual space and an utterance voice of a second user associated with a second avatar arranged in the virtual space on the basis of interest information of a first user associated with a first avatar arranged in the virtual space.

(20)

A storage medium that is readable by a computer device and stores a program for causing an arithmetic processing device to execute
a function of generating control information for performing emphasis control on audio including an environmental sound in a virtual space and an utterance voice of a second user associated with a second avatar arranged in the virtual space on the basis of interest information of a first user associated with a first avatar arranged in the virtual space.

### REFERENCE SIGNS LIST

14 Display control unit
18 Text conversion unit
21 Emphasis information generation unit
VS Virtual space
U1 First user
U2 Second user
AT1 First avatar
AT2 Second avatar
TX Three-dimensional text

1. An information processing device comprising
an emphasis information generation unit that generates control information for performing emphasis control on audio including an environmental sound in a virtual space and an utterance voice of a second user associated with a second avatar arranged in the virtual space on a basis of interest information of a first user associated with a first avatar arranged in the virtual space.

2. The information processing device according to claim 1, wherein
the interest information is information indicating a degree of interest in the environmental sound.

3. The information processing device according to claim 2, wherein
the information indicating the degree of interest is information obtained by a pointing motion of the first user.

4. The information processing device according to claim 1, wherein
the emphasis control is control for changing a volume of audio to be controlled.

5. The information processing device according to claim 1, wherein
the emphasis information generation unit includes a text conversion unit that converts the utterance voice of the second user into text.

6. The information processing device according to claim 5, wherein
the text conversion unit converts the utterance voice of the second user into the text in a case where the degree of interest in the environmental sound is high.

7. The information processing device according to claim 5, wherein
the text conversion unit converts the utterance voice of the second user into the text in a case where a degree of interest in the utterance voice is high.

8. The information processing device according to claim 5, wherein
the text conversion unit performs processing of further converting the converted text into three-dimensional character information.

9. The information processing device according to claim 8, further comprising
a display control unit that determines a display end timing for a three-dimensional object based on the three-dimensional character information.

10. The information processing device according to claim 9, wherein
the display control unit determines a timing after a lapse of a predetermined time from a start of display of the three-dimensional object as the display end timing.

11. The information processing device according to claim 9, wherein
the display control unit determines a timing at which a predetermined operation is performed on the three-dimensional object as the display end timing.

12. The information processing device according to claim 9, wherein
the display control unit determines a timing at which the three-dimensional object collides with another object arranged in the virtual space as the display end timing.

13. The information processing device according to claim 1, wherein
the emphasis information generation unit generates control information for performing visual emphasis control on a basis of the interest information.

14. The information processing device according to claim 13, wherein
the visual emphasis control is control for performing visual emphasis on the second avatar in a case where the utterance voice of the second user is of high interest.

15. The information processing device according to claim 13, wherein
the visual emphasis control is control for displaying text to provide notification of an utterance of the second user in a case where the utterance voice of the second user is of high interest.

16. The information processing device according to claim 1, wherein
the emphasis control is control for changing an utterance position of the utterance voice of the second user in the virtual space in a case where the utterance voice of the second user is of high interest.

17. The information processing device according to claim 1, further comprising
an area determination unit that determines whether or not an avatar position in the virtual space is within a permitted area where a voice chat is permitted.

18. The information processing device according to claim 17, wherein
the emphasis information generation unit generates control information for performing emphasis control on the utterance voice in a case where the first avatar is located in the permitted area.

19. An information processing method for causing a computer device to execute
processing of generating control information for performing emphasis control on audio including an environmental sound in a virtual space and an utterance voice of a second user associated with a second avatar arranged in the virtual space on a basis of interest information of a first user associated with a first avatar arranged in the virtual space.

20. A storage medium that is readable by a computer device and stores a program for causing an arithmetic processing device to execute
a function of generating control information for performing emphasis control on audio including an environmental sound in a virtual space and an utterance voice of a second user associated with a second avatar arranged in the virtual space on a basis of interest information of a first user associated with a first avatar arranged in the virtual space.
